(19) United States
(12) Patent Application Publication
(10) Pub. No.: US 2016/0229005 A1
(43) Pub. Date: Aug. 11, 2016

(54) MOBILE REPAIR AND MANUFACTURING APPARATUS AND METHOD FOR GAS TURBINE ENGINE MAINTENANCE

(71) Applicant: Siemens Energy, Inc., Orlando, FL (US)

(72) Inventors: Daniel J. Ryan, Oviedo, FL (US); Ahmed Kamel, Orlando, FL (US); Gerald J. Bruck, Titusville, FL (US); Dhafer Jouini, Orlando, FL (US)

(21) Appl. No.: 15/001,276

(22) Filed: Jan. 20, 2016

Related U.S. Application Data
(60) Provisional application No. 62/112,412, filed on Feb. 5, 2015.

(51) Int. Cl. B23P 6/00; B23K 26/70; B23K 26/342

(52) U.S. Cl. CPC B23P 6/005; B23K 26/342; B23K 26/70

(57) ABSTRACT

Refurbishment of hot gas path components of gas turbine engines can now be performed locally in lieu of the traditional use of a specialized fixed regional repair facility. A mobile manufacturing platform (10) is provided with the capability to inspect and to repair ceramic coated superalloy alloy components, including the ability to perform flux assisted laser processing (68) of powdered materials. The mobile platform may include a powder mixing capability (32) for custom on-site mixing of proprietary powder compositions from a standardized powder inventory (34). A communications element (36) conveys the proprietary powder compositions from a remote home office location (38). Superalloy components can now be repaired (62) or fabricated (80) on-site by qualified technicians rather than certified welders. The mobile platform may be self-powered by a vehicle hybrid power unit or a renewable energy source.

This application claims benefit of the 5 Feb. 2015 filing date of U.S. provisional patent application No. 62/112,412.

### FIELD OF THE INVENTION

This invention relates generally to the field of power systems maintenance services, and more particularly to the servicing of hot gas path components of a gas turbine engine.

### BACKGROUND OF THE INVENTION

Mobile machine shops are known for providing equipment repair capability. For example, the U.S. Military Ordnance Corps has mounted machine tools on a M944 truck to provide field machining capability. Mobile additive manufacturing capability is also described in United States Patent Application Publication No. US 2015/0052024 A1, however, such systems have had limited commercial application and are often limited to 3-D printing of plastic parts due to the simplicity of such a process compared to the fabrication of metal components.

Gas turbine engines are widely used in aircraft and electrical power generation plants. As the demand for more efficient power production has increased, the combustion firing temperatures of gas turbine engines have increased. Modern engines utilize exotic superalloys both with and without protective ceramic coatings in order to withstand the high temperature and corrosive atmosphere present in the combustion hot gas path. In spite of the robustness of these materials, gas turbine engine hot gas path components must be removed periodically from the engine for inspection and refurbishment.

The repair of some superalloy materials has traditionally been difficult or impossible due to the occurrence of cracking when welding these materials. Original equipment manufacturers and specialty repair vendors have established repair centers to which gas turbine engine hot gas path components are shipped for refurbishment. These repair centers contain the specialized equipment traditionally used to repair the very difficult to weld superalloy materials. These repair centers are also typically located near transportation facilities, and may be located at a geographic center of a group of clients for which they provide repair services.

Refurbishment of a component requires the component to be shipped to a repair center, which adds to the time and cost of the repair. Because down time for a power generating plant is very expensive for the owner of the plant, it is typical to have replacement hot gas path components available at the plant site for installation into the engine upon removal of the service-run components. While the cost of such replacement components may be hundreds of thousands of dollars, this procedure allows the plant to resume operation promptly while the service-run components are shipped to a repair center for refurbishment or replacement on a non-critical path basis.

### BRIEF DESCRIPTION OF THE DRAWINGS

The invention is explained in the following description in view of the drawings that show:

FIG. 1 is a schematic diagram of an apparatus in accordance with an embodiment of the invention.

FIG. 2 is a flow diagram illustrating steps of a method in accordance with an embodiment of the invention.

### DETAILED DESCRIPTION OF THE INVENTION

The present inventors are familiar with an evolving technology which facilitates the weld or braze repair of even the most difficult to weld superalloy materials. That technology involves the laser deposition of powdered superalloy material in the presence of a powdered flux material. The flux material cleans, shields and sometimes adds constituents to the melted superalloy material, and it facilitates crack-free welding with the component at room temperature for superalloys that previously were either impossible to weld or could only be welded using a hot box technique with rigorous temperature and atmospheric control. This technology is generally referred to by the assignee of the present invention under its mark “SieFlux”. Examples of this technology are taught in pending United States patent applications, among which include publication numbers US 2013/0136868 A1, US 2013/0140278 A1, and US 2013/0140279 A1, all of which are incorporated by reference herein.

The present inventors have discovered that it is now possible to significantly reduce the cost for repairs of superalloy gas turbine engine components by utilizing a SieFlux™ repair process enabled as a mobile manufacturing platform. The mobile platform is delivered to proximate a power plant site location or an airframe maintenance facility where it is operated to accomplish the repairs. Local gas turbine engine component repair is currently not available in the industry, and it is anticipated that this invention will improve the turnaround time and lower the cost of such repairs.

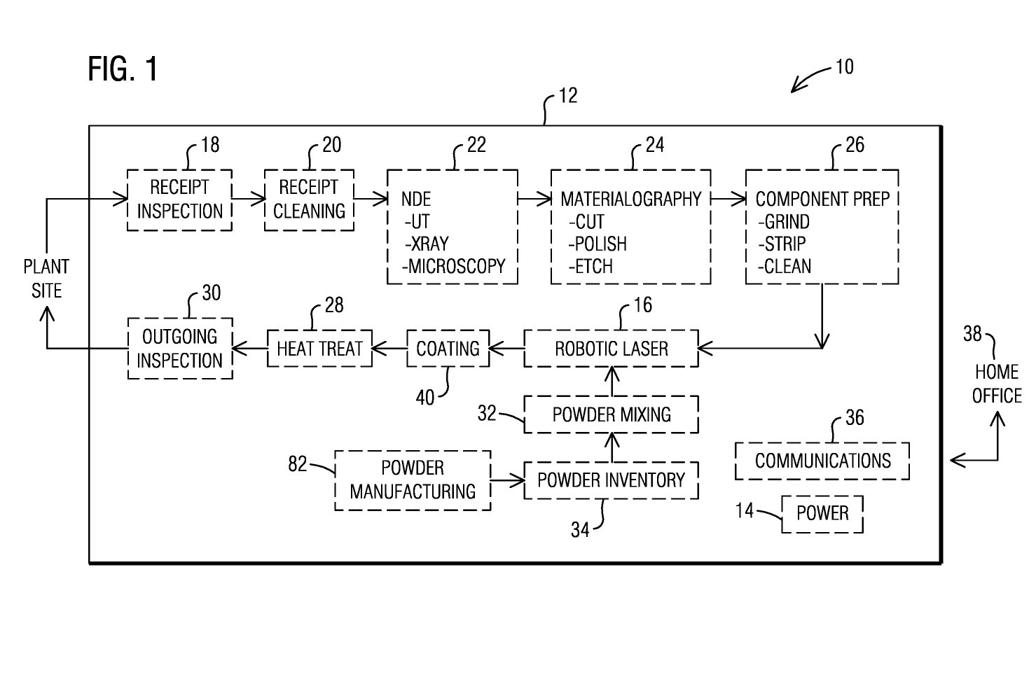

As is illustrated in FIG. 1, the mobile manufacturing platform 10 is supported on a transportation element 12 that can be moved from one location to another. The transportation element may be a truck, trailer, railroad car, skid, etc., or other single or multiple structures that are either self-propelled or that can be loaded onto a conveyance. The transportation element 12 may be transported by road, rail, air or water. In one embodiment, the transportation element may be a truck powered by a Siemens ELFA® hybrid drive system, where the drive system is configured to function as a power element 14 to provide electrical power for the repair processes once the truck is parked at the plant site location, thereby eliminating the need for providing utility grid power to the mobile manufacturing platform 10 and making it a self-sustained system. Optionally, a renewable energy generation capability, for example solar or wind power, may be used to provide electrical power for the mobile manufacturing platform. Furthermore, the mobile manufacturing platform may also be powered at least partly by utility grid power or entirely by utility grid power as dictated by the power requirements of the mobile manufacturing platform.

The mobile manufacturing platform includes machines and tools appropriate to facilitate the inspection and repair of gas turbine engine components, including a robotically controlled laser processing element 16 such as is used to melt superalloy and flux powders during a SieFlux™ repair process. One such machine is a Kuka KR60-3 robot and KCP2 pendant supporting an IPG Photonics high power (e.g. 8 kW) three dimensional optical scanner system directing energy from an IPG Photonics ytterbium fiber laser source. The laser element 16 may include one or multiple lasers, including lasers producing energy with different wavelengths or with tunable wavelengths (e.g. 532-1064 nm) as may be preferred for processing both metallic and ceramic materials as well as for performing cleaning, welding, brazing and heat treating processes. The robotic laser element 16 may further include powder delivery capability for blown powder deposition processes, or powder bed spreading capability for powder bed processing. While some alloy powder deposition processes require the use of a cover gas, such as an inert gas, some SieFlux™ alloy deposition processes do not require a cover gas, relying instead on the production of a protective slag to protect the molten and/or cooling material from the atmosphere. Advantageously, an embodiment of the mobile manufacturing platform 10 may specifically exclude any gas storage or processing equipment, thereby reducing weight and space requirements and enhancing safety during transportation of the platform 10.

As further illustrated in FIG. 1, the mobile manufacturing platform may include some or all of the following elements and capabilities: receipt inspection 18; component cleaning 20; non-destructive examination 22, such as ultrasonic, X-ray and/or microscopy; materialography 24, including the capability to cut, polish and etch material samples; component preparation 26 such as grinding, stripping and chemical cleaning; heat treating 28; and outgoing inspection 30.

In one embodiment, the powdered material used on the mobile manufacturing platform 10 are shipped and stored on-board the mobile platform 10 or are shipped separately to the repair location site. The mobile manufacturing platform 10 may include a powder mixing element 32 for custom mixing of powder compositions from an inventory 34 of standard constituent metal, alloy, ceramic and flux powders. Once the hot gas path components are removed from the gas turbine engine and a necessary repair regiment is determined, the type(s) and quantity of repair powder(s) can be determined based upon a selected repair procedure(s). The repair powder(s) is then prepared in the powder mixing element 32 using appropriate quantities of the required constituent powders selected from the inventory 34 available with the mobile platform 10. Advantageously, a smaller total quantity of powder may be required to be shipped with the mobile repair platform 10 as a result of on-site mixing, since duplicate volumes of common constituent powders used in alternative processes may be eliminated, and statistically conservative reserve amounts of common constituent powders used in multiple processes may be reduced without increasing the risk of depleting the supply of any particular powder.

Formulas for various powder mixes may be considered proprietary and may be stored on the mobile platform 10 in an encrypted form. Operation of the powder mixing element 32 may be limited to personnel having a required security clearance. The mobile platform 10 may further include a communications element 36 that provides a data link with a remote home office location 38. The communications element 36 may be linked to the powder mixing element 32 for conveying proprietary powder mixing data. In this embodiment, proprietary powder compositions need never be shipped to or stored on-site, but rather, the proprietary compositions can be created on an as-needed basis in response to encoded information transmitted to the powder mixing element 32 from the home office location 38.

Upon removal from a gas turbine engine, a component to be serviced is inspected, typically with visual, surface penetrant and/or ultrasonic techniques. The inspection element 18 on the mobile platform 10 provides space and equipment for such inspections.

Component repairs may require one or more material removal operations, such as grinding out cracked material and/or stripping of ceramic thermal barrier coating material. The mobile platform may be provided with the component preparation element 26 to accomplish these operations.

Advantageously, the laser element 16 may be used with customized SieFlux™ fluxes for stripping and recoating of ceramic thermal barrier coatings. See, for example, co-pending United States Patent Application Publication No. US 2015/0151339 A1 titled Flux Assisted Laser Removal of Thermal Barrier Coating, incorporated by reference herein. Alternatively, a separate coating element 40 may be provided. The laser element 16 may also be used for heat treatment processes, and/or the mobile manufacturing platform 10 may be provided with a separate heat treatment element 28.

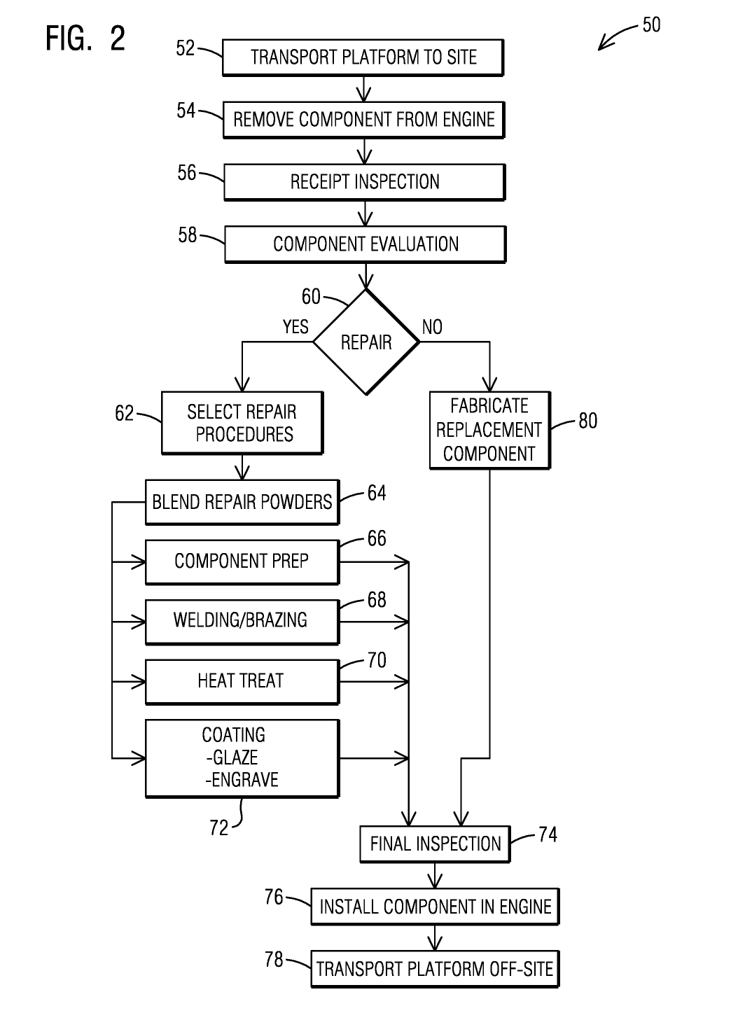

A procedure 50 in accordance with an embodiment of the invention is illustrated in FIG. 2 for the repair of gas turbine engine components for a utility power plant. A mobile manufacturing platform 10 such as the one illustrated in FIG. 1 is first transported 52 to or proximate a gas turbine engine plant site. The term “plant site” is used herein broadly to include not only a property on which the plant is built, but also to include nearby local property that is conveniently local to the plant property. Utility personnel responsible for turbine engine component repairs often desire to inspect the components during various stages of a refurbishment regiment. Locating the mobile manufacturing platform proximate the plant site facilitates the efforts of the utility personnel and reduces their time/cost. Moreover, local repair of components eliminates the time, cost and risk associated with shipping the components to a remote repair facility location, including eliminating the need for any international shipment. In some cases it may eliminate the need to provide a spare set of hot gas path components, potentially saving the utility owner of the plant hundreds of thousands of dollars.

Upon shutdown of the plant, the hot gas path components of the gas turbine engine are removed from the engine 54 and are transferred to the mobile manufacturing platform for inspection 56. A determination is made 58 whether or not each component can or cannot be repaired 60, and if so, appropriate pre-qualified repair procedures are selected 62. The determination of an appropriate repair procedure may be based upon a rule-based decision tree that is followed locally, or home office engineering input may be obtained by communicating the inspection results electronically to an off-site location. For example, degraded thermal barrier coating material may need to be removed, degraded superalloy material may need to be removed, superalloy material may require weld or braze repair, cooling holes may require redrilling (e.g. a laser subtractive process), and/or coating material may need to be reapplied, glazed and/or engraved. Advantageously, flux assisted material removal and material addition processes developed under the SieFlux™ brand enable these operations to be conducted with the computer-controlled laser equipment 16 available on the mobile manufacturing platform 10. Moreover, these operations can be performed by technicians who are trained and qualified to operate the robotic laser welding equipment 16, rather than by certified manual welders. Once a SieFlux™ repair procedure is qualified, only pre-repair equipment calibration and periodic in-process variable confirmations are necessary to ensure a successful repair operation. This expands the repair capability of the power plant service industry, since the availability and travel constraints of certified manual welders is no longer a limiting asset. Moreover, repair process instructions, control and quality monitoring may be accomplished at least in part from a remote home office location 38 via the communications element 36. In this manner proprietary process control information need reside at the repair location only as transient electronic information, and the skill and qualification level for on-site personnel may be further reduced without affecting the quality of the repair operation.

The composition and quantity of powder material necessary for each repair operation may be unique and will vary depending upon the component alloy, the results of the component inspections, and the selected repair process (e.g. cleaning, brazing, welding, coating, heat treating, etc.). The required repair powder can be custom mixed 64 on the mobile manufacturing platform 10 once the necessary repair operations are determined. Quantities of proprietary powder compositions can be maintained at a minimum and their distribution thus more carefully monitored. Formulas for proprietary powder mixtures may reside only at the central home office location 38 and may exist at the plant site only as transient electronic instructions.

The required repair procedures, such as component preparation 66, welding or brazing 68, heat treating 70 and/or coating 72 are then implemented on the mobile manufacturing platform, and a final inspection 74 of the repaired component is performed prior to its reinstallation 76 into the gas turbine engine. Upon completion of the repairs, the mobile manufacturing platform is available for transportation 78 to another plant site.

The capability of the mobile manufacturing platform is not necessarily limited to repair operations. If the inspection of a component reveals that it is too degraded to be refurbished economically, then a completely new component may be fabricated 80 using the flux assisted additive manufacturing capabilities of the mobile manufacturing platform 10. This capability further reduces the risk of plant restart delays in the event of unanticipated component degradation, and it further reduces the need for having a complete set of replacement parts available at the plant site prior to the maintenance outage. Elimination of unnecessary, costly inventory and of its storage represent significant benefits to the plant owners. Moreover, component upgrades may be accomplished using the mobile manufacturing platform. By eliminating the need to ship components to an off-site, fixed manufacturing facility, it may be possible to upgrade certain components during relatively short plant shutdown periods rather than delaying such upgrades until a full plant maintenance outage is scheduled.

The flexibility of the mobile manufacturing platform 10 may be further increased by incorporating a custom powder manufacturing element 82. While the number and quantity of powders needed in the powder inventor 34 are minimized by the on-board powder mixing element 32, there may be some laser welding or laser brazing procedures which require a hybrid powder containing both alloy and flux materials in each particle, while other procedures require flux particles to be mixed with alloy particles or to be deposited on top of the alloy particles. A miniature atomization unit, such as one described in U.S. Pat. No. 8,640,975 B2, may be included in the powder manufacturing element 82 to facilitate on-site combining of alloy and flux materials into composite particles and/or multi-material deposition.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
providing a mobile manufacturing platform comprising a laser processing element;
transporting the mobile manufacturing platform to proximate a location of a gas turbine engine to be serviced;
transferring a service run hot gas path component removed from the gas turbine engine to the mobile manufacturing platform;
inspecting the service run component and determining a necessary repair or alternatively a need for the service run component to be scrapped and replaced with a replacement component;
repairing a superalloy material portion of the service run component, or alternatively fabricating the replacement component comprising superalloy material, with the laser processing element using a flux assisted process; and
installing the repaired component, or alternatively the replacement component, into the gas turbine engine.

2. The method of claim 1, further comprising mixing a powder mixture appropriate for the repairing or fabricating step in a powder mixing element of the mobile manufacturing platform.

3. The method of claim 2, further comprising providing instructions for performing the mixing step from a remote location via a communications element of the mobile manufacturing platform such that a formulation of the powder mixture exists at the mobile manufacturing platform only as a transient electronic instruction.

4. The method of claim 2, further comprising mixing the appropriate powder mixture from a group of constituent powders maintained in a powder inventory of the mobile manufacturing platform.

5. The method of claim 4, wherein the powder inventory comprises at least two of the group of metal, alloy, ceramic and flux powders.

6. The method of claim 1, further comprising preparing a powder appropriate for the repairing or fabricating step in a powder manufacturing element of the mobile manufacturing platform.

7. The method of claim 6, further comprising preparing a powder comprising composite alloy/flux particles in the powder manufacturing element.

8. The method of claim 1, further comprising utilizing the laser processing element to perform a flux assisted cleaning of the service run component.

9. The method of claim 1, further comprising utilizing the laser processing element to perform a heat treatment of the repaired component or alternatively the replacement component.

10. The method of claim 1, further comprising providing the laser processing element to have a tunable laser frequency capability to facilitate processing of a plurality of types of materials.

11. A mobile manufacturing platform apparatus comprising:
a transportation element configured for movement among any of a plurality of locations;
a laser processing element disposed on the transportation element; and
a powder mixing element disposed on the transportation element for mixing powder material compositions for use by the laser processing element.

12. The apparatus of claim 11, further comprising a communications element associated with the transportation element operable to receive transient electronic powder material composition information from a remote location for operating the powder mixing element.

13. The apparatus of claim 12, further comprising an inventory of constituent powders in a powder inventory.

14. The apparatus of claim 13, further comprising a flux material in the powder inventory.

15. The apparatus of claim 14, further comprising no shielding gas stored on the transportation element.

16. The apparatus of claim 11, wherein the transportation element comprises a hybrid drive system configured to function as a power element to provide electrical power for the mobile manufacturing platform.

17. The apparatus of claim 11, wherein the laser processing element comprises a tunable laser.

18. The apparatus of claim 11, wherein the laser processing element comprises a powder manufacturing element.

19. The apparatus of claim 11, further comprising a heat treating element, wherein the heat treating element comprises a laser of the laser processing element.

20. The apparatus of claim 11, further comprising a component preparation element, wherein the component preparation element comprises a laser of the laser processing element.
